(19) United States
(12) Patent Application Publication
(10) Pub. No.: US 2026/0200532 A1
(43) Pub. Date: Jul. 16, 2026

(54) MONOLITHIC CHASSIS AND A METHOD OF MAKING THE SAME

(71) Applicant: Kerry N. Hitt, Harrisburg, PA (US)

(72) Inventor: Kerry N. Hitt, Harrisburg, PA (US)

(21) Appl. No.: 19/022,394

(22) Filed: Jan. 15, 2025

(51) Int. Cl. B62D 23/00; B62D 25/20; B62D 29/04; B62D 31/00; B62D 61/08; B62D 65/00

(52) U.S. Cl. CPC B62D 23/00; B62D 25/20; B62D 29/041; B62D 29/043; B62D 29/046; B62D 31/003; B62D 65/00; B62D 61/08

(57) ABSTRACT

A monolithic chassis employed as a platform to construct a motor vehicle. The chassis includes a platform having a channel and floorboards connected to both sides of the channel, wherein a structural tube is operatively associated with the channel after laying a first composite material over the platform. A second composite material is lain over the nest structural tube protruding from the channel and the first composite material over the floorboards, thereby encapsulating the nested structural tube through lamination of the first and second composite materials.

### BACKGROUND OF THE SUBJECT DISCLOSURE

The present subject disclosure relates to vehicular chassis and, more particularly, to a monolithic chassis used as a platform to construct a motor vehicle, and a method of making the monolithic chassis from layers of composite materials.

The lighter the vehicle the more money saved in terms of the operable power and energy needed, which would be a boon for the seemingly full-scale transition to electric vehicles as they tend to be heavier than combustion engine vehicles since the lighter the chassis the lighter the resulting vehicle, and so the less motive energy needed for the underlying vehicle.

Moreover, vehicles are built from the chassis up, and so cost savings and efficiencies, as well as flexibility, could be realized building a variety of fleets of cars from the same monolithic chassis or platform.

As can be seen, there is a need for a monolithic chassis used as a platform to construct a motor vehicle, and a method of making the monolithic chassis from layers of composite materials.

### SUMMARY OF THE SUBJECT DISCLOSURE

The subject disclosure provides a platform for which to build a lightweight motorized vehicle using a minimum number of parts and pieces. Particularly, through the use of composite materials, the structure and allocation of components of the subject disclosure allows for the lightest weight platform to carry the mechanical loads necessary to build a functional vehicle. In other words, the present subject disclosure is lighter, therefore more energy efficient than conventional vehicle chassis, and so can be built using less infrastructure investment.

Such a monolithic chassis would provide options for manufacturing that can be used in less industrialized countries. Also, utilizing a chassis that is composed of rust-proof material will realize long term savings related to maintenance and bluebook valuations.

Furthermore, use of composite materials is advantageous in how loads are carried generally, and specifically in a vehicular chassis. When a composite structure is designed to be optimized, the overall look of the resulting chassis will be selectively different than a design using conventional materials such as metal.

In short, the advantage of building an automotive chassis from composite materials is that the sum strength of the combined materials is synergistic, therefore, it enables building strong lightweight chassis components. Additionally, if proper engineering of an automobile chassis is done and the orientation of the composite materials used to build the chassis is correct, then the control the rate of failure, should an impact occur, enables the chassis to absorb energy in a collision, instead of transferring the energy absorption to the bodies of the occupants inside the vehicle.

Since there are many methods of manufacturing the disclosure, the subject disclosure lends itself to being manufactured in areas where the investment of labor is more desirable than the investment of infrastructure.

In one aspect of the subject disclosure, a vehicular chassis provides the following: a platform comprising a channel and two floorboards, each floorboard cantilevering from the channel in opposite directions; a first composite material lain over said channel and two floorboards; a structural tube nested in the channel over the first composite material therein; and a second composite material lain over the first composite material along the two floorboards and along an exposed surface of the nested structural tube, thereby encapsulating the structural tube between the first and second composite layers; and a core disposed between the first and second composite layers and between the exposed surface of the nested structural tube and the second composite layer, wherein each composite material comprises a liquid resin woven with a plasticized material forming a laminate, and wherein the laminate is interwoven with a load-bearing fiber to form a matrix.

In another aspect of the subject disclosure the vehicular chassis further includes the following: a core disposed between the first and second composite layers and between the exposed surface of the nested structural tube and the second composite layer, wherein each composite material comprises two woven fibrous materials, wherein each composite material is lain at a predetermined orientation relative to a center longitudinal line of the nested structural tube, and wherein the predetermined orientation ranges between zero and ninety degrees.

In yet another aspect of the subject disclosure, a method of making a monolithic vehicular chassis includes the following: forming a structural tube around a tubular mold; forming a platform over a platform mold, wherein the platform mold comprises a channel and a first pair of floorboards comprising two floorboards extending from the channel in opposite directions; laying a first composite material over the top of the platform; nesting the structural tube in the layered channel; laying a second composite material over the first pair of floorboards and a protruding portion of the nested structural tube; de-molding the tubular mold and the platform mold; and curing the first and second composite materials so as to form the monolithic chassis; and in some embodiments, layering a core over the lain first composite material and the protruding portion of the nested structural tube before laying the second composite material, wherein each composite material is lain at a predetermined orientation relative to a center longitudinal line of the nested structural tube.

These and other features, aspects and advantages of the present subject disclosure will become better understood with reference to the following drawings, description, and claims.

### BRIEF DESCRIPTION OF THE DRAWINGS

FIG. 1 is a top perspective view of an exemplary embodiment of the subject disclosure, illustrating the underlying molds and how they operatively associate, while the composite layering is not shown.

FIG. 2 is a bottom perspective view of an exemplary embodiment of the subject disclosure, illustrating the underlying molds and how they operatively associate, while the composite layering is not shown.

FIG. 3 is a top exploded perspective view of an exemplary embodiment of the subject disclosure, illustrating the underlying molds and how they operatively associate into a nested condition, while the composite layering is not shown.

FIG. 4 is a section view taken along line 4-4 in FIG. 1.

FIG. 5 is a side elevation view of an exemplary embodiment of the subject disclosure, showing the underlying “chassis” 10 in a used condition of a three-wheel configuration for illustrative purposes as it is understood that the chassis mold 10 is not the final monolithic chassis 100 that is actually used in such configurations.

FIG. 6 is a top perspective view of an exemplary embodiment of the subject disclosure, showing the underlying molds in a pre-composite layered condition of a four-wheel configuration, for illustrative purposes as it is understood that the “chassis mold” 10 is not the final monolithic chassis 100 that would be used in such a configuration.

FIG. 7 is a side elevation view of FIG. 6.

FIG. 8 is a top perspective view of an exemplary embodiment of a structural tube 12, illustrating a first component of a method of making a monolithic chassis embodied by the subject disclosure.

FIG. 9 is a top perspective view of an exemplary embodiment of a channeled platform, illustrating a second component of the method of making a monolithic chassis embodied by the subject disclosure.

FIG. 10 is a perspective view of an exemplary embodiment of the subject disclosure, demonstrating the layering of a first composite material over the underlying channeled platform 50, with the structural tube 12 nested in the layered channel 20.

FIG. 11 is a detailed perspective view of FIG. 10.

FIG. 12 is an elevation view of an exemplary embodiment of the subject disclosure, demonstrating the layering of a second composite material over the underlying channeled platform 50, with the structural tube 12 nested in the layered channel 20.

FIG. 13 is a detailed view of FIG. 12.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

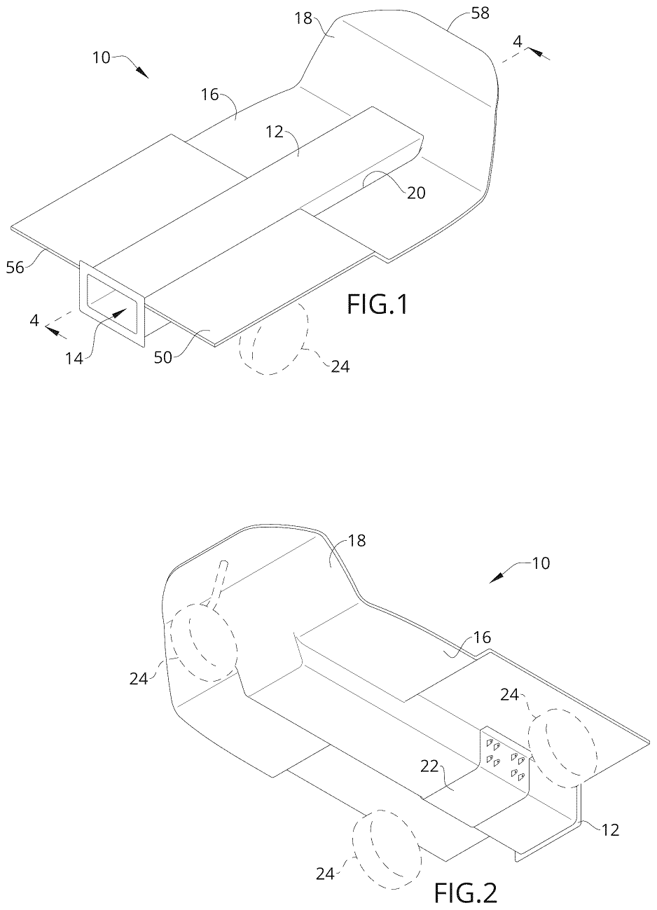

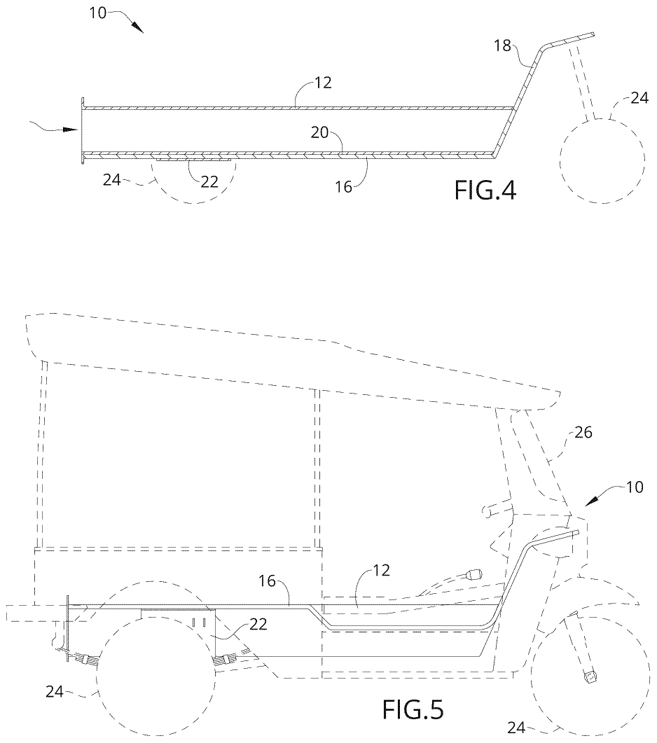

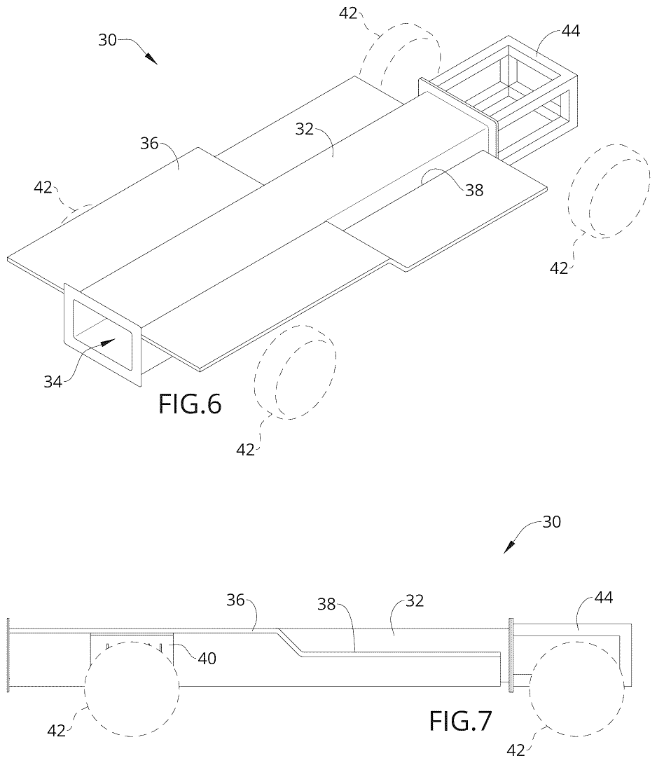

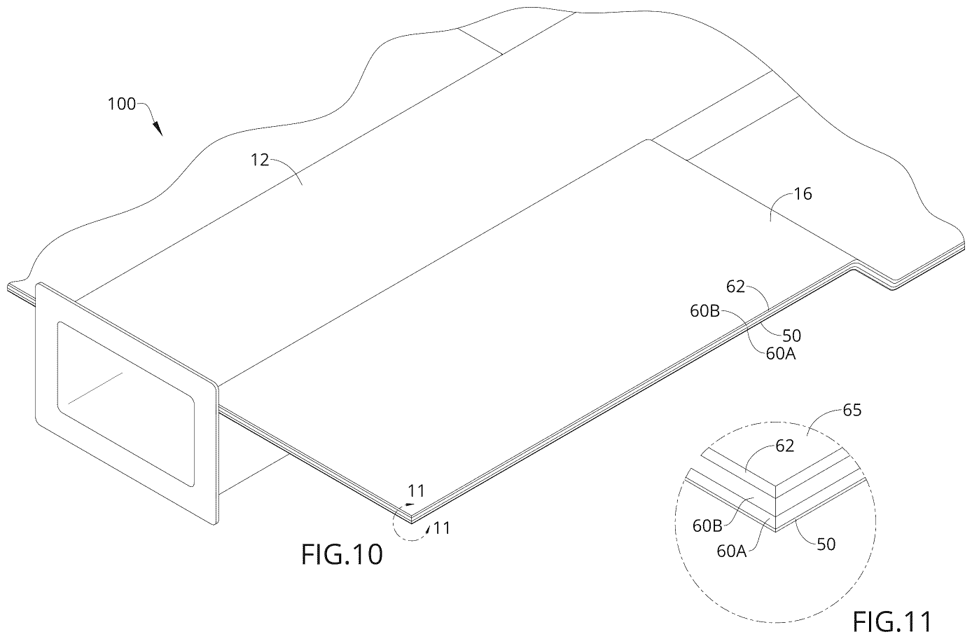

Referring to FIGS. 1 through 7, the present subject disclosure provides a “chassis” 10 providing a centrally disposed structural tube 12 (or 32) operatively associable in a nested condition with a channeled platform 50. It is noted that FIGS. 1 through 7 do not delineate the final product (or “monolithic chassis”) since the composite layering is not shown until FIG. 10, and so FIGS. 1-7 are rather offered as a forty-thousand-foot view of the two elemental components - the structural tube 12 and the channeled platform 50 - and how they operatively associate during the manufacturing process. Thus, chassis 10 can be conceived as the arrangement of two underlying chassis components (e.g., the structural tube component 12 and the channeled platform component 50 that results in a monolithic chassis only after application of the sequential layering of composite, compatible materials.

Structural tube 12 or 32 defines a lumen 14 or 34, respectively, which can be used as a passthrough space for vehicular and power systemic components as well as for storage. The structural tube 12 or 32 extends from a first end 46 to a second end 48, wherein the first end 46 is associated with the rear of the chassis 10 as understood in the context of a vehicle, and so the second end 48 is associated with the front of the vehicle in such a context.

The channeled platform 50 extends longitudinally from a first edge 56 to a second edge 58, wherein the first edge 56 is associated with the rear of the chassis 10 as understood in the context of a vehicle, and so the second edge 58 is associated with a front of the vehicle in such a context. The platform 50 provides a centrally disposed and longitudinally extending tube recess 20, 38 dimensioned and shaped to receive the structural tube 12 in the nested condition after at least a first composite layer has been lain along a top surface of the channeled platform 50. In the nested condition the first end 46 and the first edge 56 may align or be substantially flush. In other embodiments, the first end 46 may provide a radially disposed flange 60 that engages the first edge 56 as shown in the Figures.

A frame bucket 22, 40 may be provided as an arch-shaped clip dimensioned and shaped to snugly engage an underside of the tube recess 20, 38, thereby clamping or otherwise urging the structural tube 12 or 32 to be rigidly fixed to or mechanically communicative with the tube channel 20 or 38, respectively, in the nested condition.

The channeled platform 50 may have a plurality of levels, elevations, or floors 16, 36, 18, 44, and the like. A chassis floor 16, 36 may extend from the first edge 56 to a transition edge 70. From the transition edge 70, the channeled platform 50 may angle relative to the planar chassis floor 16, 36 as the channeled platform 50 extends along the longitudinal direction (though there are some embodiments the transition zone associated with the transition edge could angularly incline, even though not shown in the appended Figures) to an intermediate floor 80. At a distal (relative to the first edge 56) longitudinal edge of the intermediate floor 80 may incline from said distal longitudinal edge. In some embodiments, a front floor 44 may be a rectangular frame element as opposed to a uniform continuous sheet.

Wheels 24, 42 can be operatively associated with an underside of the chassis floor 16, 36 and front floor 18,44 or otherwise underneath the channeled platform 50 to enable a three-wheel and four-wheel vehicle configurations 26, 30, respectively.

As a result, the subject disclosure enables a platform from which a motor vehicle can be built, whereby the assembly embodied by the present subject disclosure would be the main structural element from which the vehicle would be built.

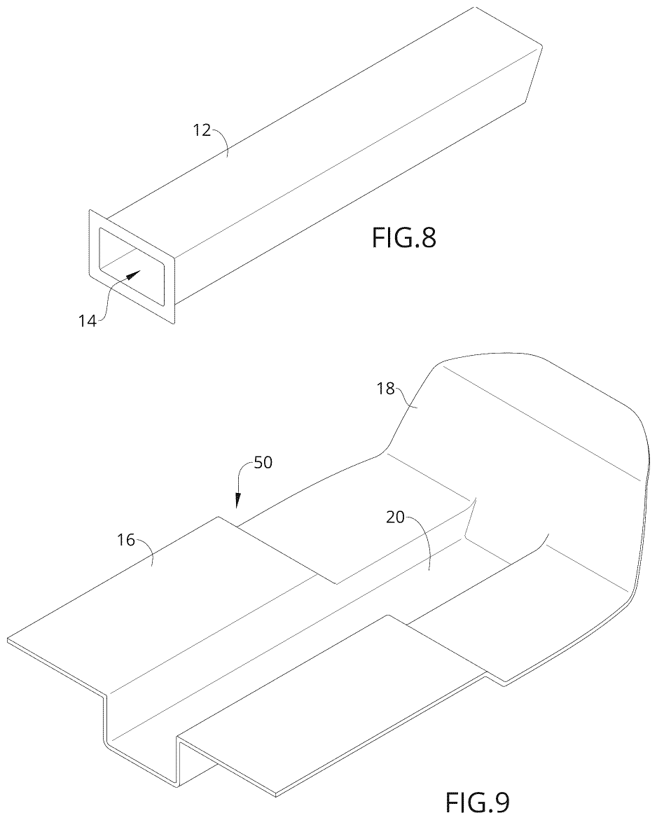

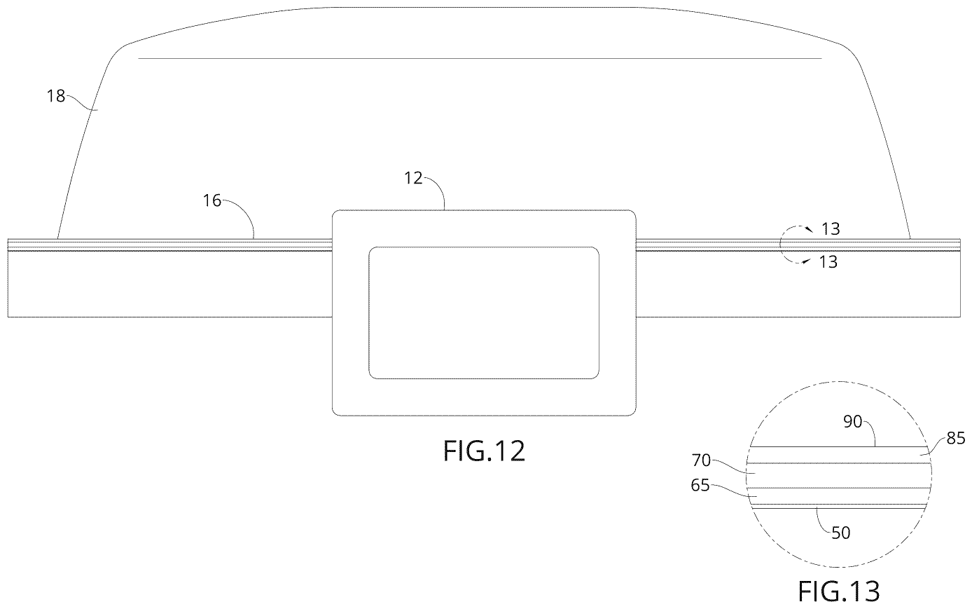

Referring to FIGS. 8 through 13, the subject disclosure includes a method of making a monolithic chassis 100 through the sequential layering of composite materials. The structural tube 12 may have various geometric cross-sections (rectangular, oval, circular, square) and may be manufactured using one or more processes wherein two or more compatible materials are combined so that the combination of those materials creates a sum strength greater than the strength of each one individually. The composite materials that could be used are fiberglass reinforcement, carbon fiber reinforcement, Kevlar reinforcement, foam core, honeycomb core, Polyester resin, Epoxy resin. The true advantage in using composite materials is how the load is carried-when a composite structure is designed to be optimized, the overall look can be selectively different than a design using conventional materials such as metal.

The channeled platform 50 will be combined with the structural tube 12 using a primary or secondary operation that will result in the structural tube 12 and the one or more levels/floors of the channeled platform 50 creating a one-piece monolithic platform to which the suspension and the drive unit assemblies can be attached by using mechanical fasteners or with an adhesive.

The formation of the monolithic chassis is a multi-step process including the following components.

Tooling (molds) may be necessary to build the first and second components (structural tube 12 and channeled platform 50) that will eventually be bonded and encapsulated to become one monolithic structure that will be the monolithic chassis 100. The tooling for the first component—the structural tube 12 (see FIG. 8)—is the main structural component of the chassis. Tooling for the second component—the channeled platform 50—provides a channel 20 that will be the final bed or seat for the structural tube of the monolithic chassis 100. The channeled platform 50 may be associated with “floorboard tooling” since the channel 20 also provides support for floorboard elements that cantilever off opposing sides thereof.

There could be a myriad of possibilities for a lay-up schedule, which is a listing of the type of material along with the sequence followed to create a lamination of the chassis mold 10 that results in the finished monolithic chassis 100. Although there could be many different types, styles, and materials used in the lay-up schedule, it would provide at least two types of material. One of the types of material—the first material—could be a liquid resin 60A, which is almost always a two-part thermoset resin, which would bond to or be bonded to or with another type of material, which is almost always fibrous 60B. The combination of these materials is referred to as a laminate 65/85. The second type of material - the second material 62—would almost always be a fiber of some kind and would be the main load bearing material of the structure. This fibrous material in most cases could be either a woven, unidirectional or omnidirectional fiber configuration.

The combination of the first material 65 and the second material 85 will create a matrix 90. The number of materials along with the amount of each individual material used could be higher than two, though for demonstrative purposes the disclosure (see FIGS. 10 and 11) uses only two composite layers. In some embodiments, the first material is called the ‘laminate’, and the combination of the first material and the second material is called the ‘matrix’.

The type of fiber, and the type of weave or the orientation of the fiber as a cloth, before the impregnation of a liquid thermosetting resin, along with the number of layers of the woven configuration of that fiber, will be a determining factor of the composite design. Additionally, the type of fiber, and the type of weave or the orientation of the fiber as a cloth “after” the impregnation of a liquid thermosetting resin will be contributing factors to the design. These factors, along with the use of an optional core 70, are all determining factors when doing a composite design. The core 70 could be several materials. It could be honeycomb, (which can be made from paper, Nomex, plastic or aluminum). It could also be some type of foam made from numerous materials. It could even be wood. The term for this type of construction is called “sandwich construction” It is used when a core material is used to separate two layers of composite material.

When the two composite layers are bonded to the core on opposite sides of each other, and the core is in the middle separating the two. One layer becomes a tension plane, and the other layer becomes the compression plane. It is the same principle present in a structural I-beam wherein there is a tension plane and a compression plane separated by a web. In this case the core is performing the same task as the web in holding the tension and compression plane in constant separation from each other. This principle is used in an application where stiffness is desired.

Two different composite structures (or items or parts) can be made from the same mold, and each one could be designed to reflect two completely different structural characteristics.

The structural tube is the first to be built. It is made over the outside of a mold (for the purposes of this explanation, the words “mold” and “tooling” are synonymous. The mold will be designed and built in a way that will allow sufficient draft to de-mold the finished part. The mold may also be built with two tapered pieces. This will allow the finished part to be removed from the mold but will keep the outside dimensions of the finished tube to be parallel.

In the case of a square or rectangular tube, the mold would be on the inside of the tube. The tube would be manufactured by putting fiber material mixed with a thermoset resin over the outside of the mold. The ends of the tube would be open. In this case, in order to remove the mold from the finished tube, the mold would be made having two parts to the tube that would be tapered like two wedges, that when put together, would form the square or rectangle shape to be molded. When the time comes to remove the mold from the inside of the tube, one end of one wedge could be attached to a solid stationary object and the opposite end of the second wedge would be attached to a hydraulic or mechanical mechanism and the two wedges would be separated by pulling them apart in opposite directions. This method would cut the resistance met by the tubes being withdrawn in halves, because as the wedges are moved, they immediately become smaller because they move away from half the surface area of the tube.

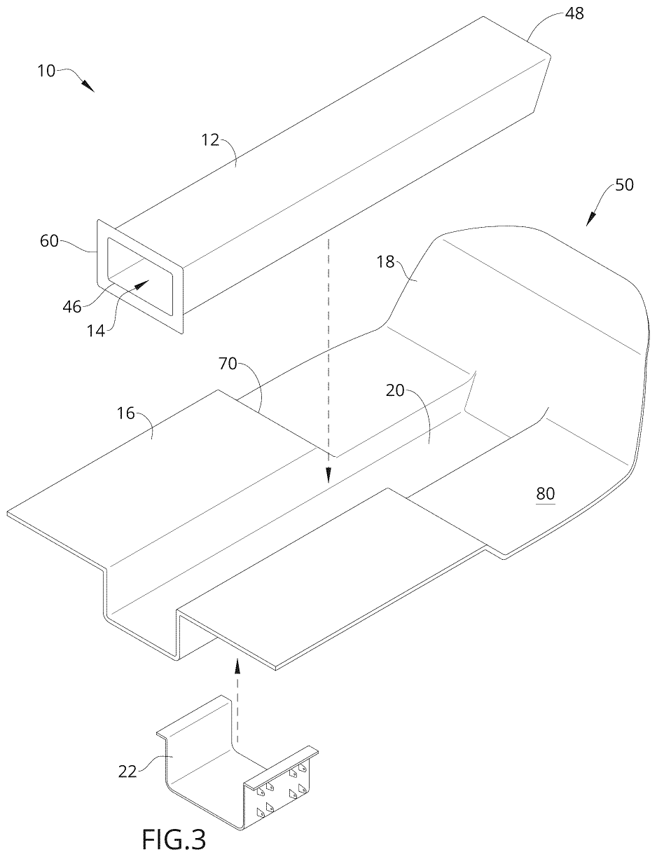

The second part will be built by placing a composite material into the mold's channel and onto the mold's surface that will form the first part of the skin which will be the floorboard of the chassis. There will be two layers of material placed on the tooling. The materials, for the purpose of this explanation are woven fibrous materials. They will be pre-impregnated with the resin. They will be placed and oriented to the center line of the tube's length. For this demonstration only, they will be placed in a 0-90-degree orientation. The next step will be to place the structural tube into the channel on top of the material that was just placed in the channel (see FIG. 3). This step requires the mold to stay inside the tube. The next step is to place a core material on the flat surface of the material that is in place on the flat surface of the Floorboard tooling. The next step is to place material on the top of the core material and over the tube at a 0-90-degree orientation.

In a product manufactured using composite material, wherein there is a fiber which is held in place by a thermoset resin (which is a plasticized material), most of the structural load is carried by the fiber and the resin functions mostly as a glue that holds it in place. Most products manufactured using fiber reinforced plastics are strongest when designed to take advantage of the strengths of the fibers used. Different fibers have different strengths and carry loads differently. There is a myriad of combinations that can be used to achieve the desired strengths and functions of products made from reinforced plastics and the combination of materials.

The definition of a composite material is two or more compatible materials whose sum strengths are synergistic. The strength of the part is optimized by the orientation of fibers and by placing them in specific directions. By way of example, if an item must be very stiff in one specific direction, as would be a five-foot long wing on a race car, which is supported by a mount in the middle of the wing, the strength would be needed to counteract the downforce generated by the wing. This strength would be obtained by laminating layers and placing a larger number of the layers with fiber oriented in a 0-degree configuration using a unidirectional fiber cloth. A lesser number of layers would be oriented in a plus or minus 45-degree configuration to carry lesser loads. However, if the wing would see loads that would occur in a different direction, for example in a mock-1 aircraft moving forward, the loads would be calculated differently consequently, there would be layers of fiber that would be oriented differently in order to carry the loads. Typically, a part that is manufactured using composite materials would look entirely different than a part that is manufactured using conventional materials like metals, unreinforced plastic or aggregate. It is conceivable to have two identical looking parts that would carry loads completely opposite of each other. That conceivability would be totally dependent on the orientation of the fiber.

After completion of the application of the composite materials on the chassis mold, the combination of the chassis mold 10 and composite layers are ready to be put in a totally enclosed bag. Then the bag is subject to a vacuum and the components are ready to be cured. After the overall combination is cured, the bag is removed, and the mold for the structural tube 12 is removed. The monolithic chassis 100 then is separated from the remaining platform mold for the channeled platform 50, resulting in a monolithic structure—the monolithic chassis 100—that is ready to be trimmed and assembled.

The interface between the chassis and the suspension of the vehicle along with the power unit is through a companion flange or another means of fastening two objects together on both the composite chassis and the suspension structure/assembly. The flanges can be integral to the tube and fastened via mechanical fasteners or with an adhesive.

The structural tube or tubes 12, 32 may be built using one or more methods or processes of composite construction conducive to combining two or more compatible materials in a manner that will reach the mechanical goals to meet the necessary structural integrity required to perform the task of carrying any loads that will be generated when the complete vehicle is in service.

Additional material(s) or configurations of material or a different combination of materials could be used to achieve the desired mechanical properties.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A vehicular chassis comprising:
a platform comprising a channel and two floorboards, each floorboard cantilevering from the channel in opposite directions;
a first composite material lain over said channel and two floorboards;
a structural tube nested in the channel over the first composite material therein; and
a second composite material lain over the first composite material along the two floorboards and along an exposed surface of the nested structural tube, thereby encapsulating the structural tube between the first and second composite layers.

2. The vehicular chassis of claim 1, further comprising a core disposed between the first and second composite layers and between the exposed surface of the nested structural tube and the second composite layer.

3. The vehicular chassis of claim 1, wherein each composite material comprises a liquid resin woven with a plasticized material forming a laminate.

4. The vehicular chassis of claim 3, wherein the laminate is interwoven with a load-bearing fiber to form a matrix.

5. The vehicular chassis of claim 4, wherein each composite material is lain at a predetermined orientation relative to a center longitudinal line of the nested structural tube.

6. The vehicular chassis of claim 5, wherein the predetermined orientation ranges between zero and ninety degrees.

7. A method of making a monolithic vehicular chassis, the method comprising:
forming a structural tube around a tubular mold;
forming a channeled platform over a platform mold, wherein the platform mold comprises a channel and a first pair of floorboards comprising two floorboards extending from the channel in opposite directions;
laying a first composite material over the top of the platform;
nesting the structural tube in the layered channel;
laying a second composite material over the first pair of floorboards and a protruding portion of the nested structural tube;
de-molding the tubular mold and the platform mold; and
curing the first and second composite materials so as to form the monolithic chassis.

8. The method of claim 7, further comprising layering a core over the lain first composite material and the protruding portion of the nested structural tube before laying the second composite material.

9. The method of claim 8, wherein each composite material is lain at a predetermined orientation relative to a center longitudinal line of the nested structural tube.
